(19) United States
(12) Patent Application Publication
(10) Pub. No.: US 2025/0094895 A1
(43) Pub. Date: Mar. 20, 2025

(54) SYSTEMS AND METHODS FOR TRADING SHIFT OF UNAVAILABLE PREFERENCE USING TRADE QUEUES

(71) Applicant: Nice Ltd., Ra'anana (IL)

(72) Inventors: Gaurav SURYAWANSHI, Pune (IN); Laukik PATIL, Bhiwandi (IN); Shilpa Vijay SHEGAONKAR, Pune (IN)

(73) Assignee: Nice Ltd., Ra'anana (IL)

(21) Appl. No.: 18/470,087

(22) Filed: Sep. 19, 2023

(51) Int. Cl. G06Q 10/0631

(52) U.S. Cl. CPC G06Q 10/063116

(57) ABSTRACT

Systems and methods for digital scheduling, include periodically checking a data storage for queued schedule trade requests; identifying two corresponding queued schedule trade requests; else, if two corresponding queued schedule trade requests are not identified: identifying a set of cyclic queued schedule trade requests; else, if a set of cyclic queued schedule trade requests are not identified: repeating the step of periodically checking; approving or rejecting the identified schedule trade requests based on one or more approval criteria; and if the identified schedule trade requests were approved, outputting one or more updated schedules reflecting the approved schedule trade requests.

### FIELD OF THE INVENTION

The present invention relates generally to digital scheduling, in particular cyclic queued schedule trade requests.

### BACKGROUND OF THE INVENTION

In contact centres, agents are often required to work in shifts based on the overall demand and customer service requirements. Sometimes, an agent may wish to request a trade for a particular shift that suits their personal preferences, such as for family or personal reasons. However, if the shift they require is not available at that moment, they may not be able to request a trade.

This situation can cause frustration and dissatisfaction among agents, as they may feel that they have no control over their schedules and work-life balance. It can also result in agent burnout if they consistently must work shifts that are not preferred, leading to a decline in job satisfaction and an increased likelihood of agents leaving the organization.

The problem of agents not being able to request a trade for a shift that is not yet available at that moment may arise due to various reasons such as unavailability of agents, peak seasons, limited shift availability, high demand for certain shifts, rejection by the target agents or lack of visibility into future shift availability/unpublished schedules. Existing workforce management systems may not be able to predict or anticipate specific shift requirements or agent preferences at a given time, leading to the unavailability of certain shifts.

### SUMMARY

Embodiments of the invention may allow digital alterations of records such as schedules, and allow personnel, such as agents, to request trades for shifts that are not currently available, and may thereby solve the above identified problems in the art. Accordingly, contact centres can improve agent satisfaction, reduce the risk of agent burnout, and increase the overall efficiency and effectiveness of the contact centre.

According to one or more embodiments, there is provided a method for digital scheduling, the method including, using a computer processor: periodically checking a data storage for queued schedule trade requests; identifying two corresponding queued schedule trade requests; else, if two corresponding queued schedule trade requests are not identified: identifying a set of cyclic queued schedule trade requests; else, if a set of cyclic queued schedule trade requests are not identified: repeating the step of periodically checking; approving or rejecting the identified schedule trade requests based on one or more approval criteria; and if the identified schedule trade requests were approved, outputting one or more updated schedules reflecting the approved schedule trade requests.

According to some embodiments, the method further includes periodically checking the data storage for new schedules; and identifying the two corresponding queued schedule trade requests or the set of cyclic queued schedule trade requests based on the new schedules.

According to some embodiments, the approval criteria includes a check that the trade request relates to at least one of: a tradeable activity; two or more agents in a same scheduling unit; and two or more agents with a same skill.

According to some embodiments, a schedule trade request submitted by an agent is queued if the schedule trade request relates to a date or time that is not currently available to be traded.

According to some embodiments, a queued schedule trade request remains queued until it is approved, rejected, or a predetermined period of time elapses.

According to some embodiments, the predetermined period of time expires at the date or time which is the subject of the queued schedule trade request.

According to some embodiments, the method further includes sending an approval notification to a set of agents who are the subject of an approved schedule trade request.

According to one or more embodiments, there is further provided a method for digital scheduling, the method including, using a computer processor: identifying a subset of corresponding shift-trade requests in a set of queued shift-trade requests; approving or rejecting the identified subset of corresponding shift-trade requests according to a set of approval criteria; and outputting a notification of the approval or rejection thereof.

According to some embodiments, this method further includes outputting an updated schedule for an approved shift-trade request.

According to some embodiments, a shift-trade request is a queued shift-trade request if at the time an agent submitted the shift-trade request the shift did not exist to be traded.

According to one or more embodiments, there is also provided a system for digital scheduling, the system including: at least one processor; and a memory containing instructions which, when executed by the at least one processor cause the at least one processor to: periodically check a data storage for queued schedule trade requests; identify two corresponding queued schedule trade requests; else, if two corresponding queued schedule trade requests are not identified: identify a set of cyclic queued schedule trade requests; else, if a set of cyclic queued schedule trade requests are not identified: repeat the step of periodically checking; approve or reject the identified schedule trade requests based on one or more approval criteria; and if the identified schedule trade requests were approved, to output one or more updated schedules reflecting the approved schedule trade requests.

According to some embodiments, the at least one processor is further configured to: periodically check the data storage for new schedules; and identify the two corresponding queued schedule trade requests or the set of cyclic queued schedule trade requests based on the new schedules.

According to some embodiments, the at least one processor is further configured to send an approval notification to a set of agents who are the subject of an approved schedule trade request.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows a flowchart of a method for digital scheduling, according to some embodiments of the invention;

FIG. 3 shows an example of a set of cyclic trades, according to some embodiments of the invention;

FIG. 4 shows a flowchart of a method for digital scheduling, according to some embodiments of the invention;

FIG. 5 shows a flowchart of a method according to some embodiments of the invention;

FIG. 6 shows a flow diagram according to some embodiments of the invention;

FIGS. 7A and 7B show an example according to some embodiments of the invention;

FIG. 8 shows a component diagram, according to some embodiments of the invention;

FIG. 9 shows example data structures which may be used by embodiments of the invention;

FIGS. 10A, 10B, and 10C show example user interfaces which may be used with embodiments of the invention;

FIG. 11 shows an example simulation, according to some embodiments of the invention; and

FIG. 12 shows some example data in relation to embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to digital scheduling.

As used herein, “Call Center” may refer to a centralized office used for receiving or transmitting a large volume of enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center worker that answers incoming contacts, handles customer requests and so on. Workers other than agents may use embodiments of the present invention.

As used herein, “Work Force Management (WFM)” may refer to an integrated set of processes that a company uses to optimize the productivity of its employees. WFM involves effectively forecasting staffing requirements and creating and managing staff schedules to accomplish a particular task on a day-to-day and hour-to-hour basis. Embodiments of the invention may be part of, integrated with, or otherwise interact with new and existing WFM technology and processes.

As used herein, “Staffing Requirements” may refer to the required amount of personnel (e.g. agents) needed at a contact center to handle expected/forecasted contacts in accordance with quality-of-service metrics. Embodiments of the invention may ensure that staffing requirements are met by, for example, only allowing shift trades where both agents have a common skill such that the required staffing for that skill is preserved for the time periods of the traded shifts.

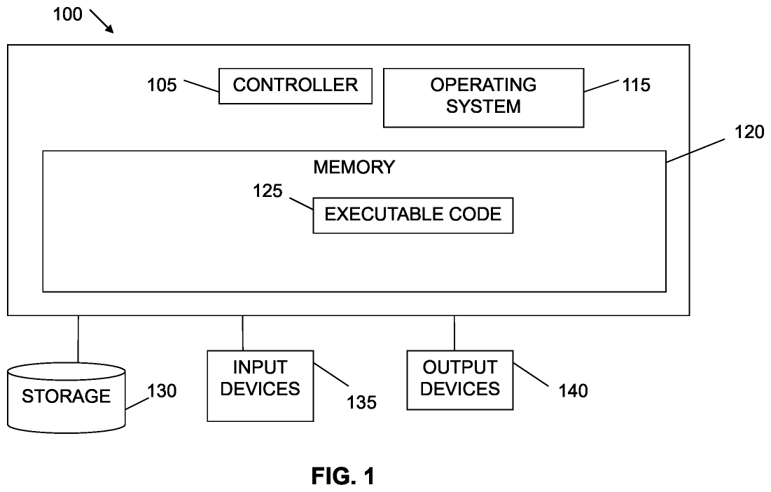

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out methods as disclosed herein, and/or data as disclosed herein such as agent data (e.g. skill data), schedule data (e.g. shift times, scheduled work days, scheduling unit), shift parameters, agent preferences, approval criteria, validation criteria, or any other type of data.

Executable code 125 may be any application, program, process, task, or script. Executable code 125 may be executed by controller 105 possibly under control of operating system 115. For example, executable code 125 may be or execute one or more applications performing methods as disclosed herein, such as for updating an assignment of resources. In some embodiments, more than one computing device 100 or components of device 100 may be used. One or more processor(s) 105 may be configured to carry out embodiments of the present invention by, for example, executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

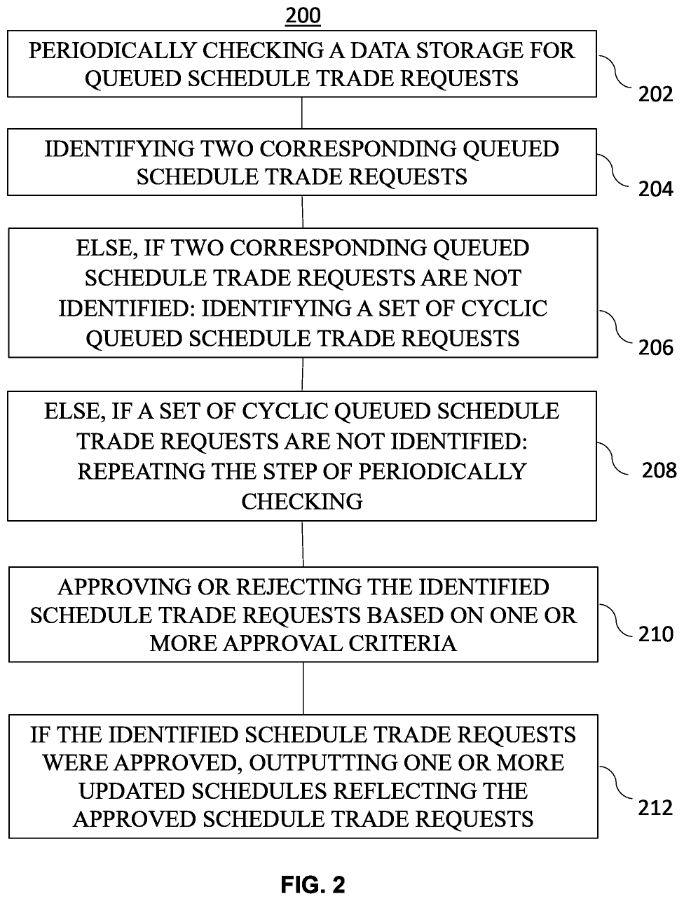

FIG. 2 shows a flowchart of a method 200 for digital scheduling, according to some embodiments of the invention. Method 200 may be a computer implemented method, for example one or more steps of method 200 may be carried out in part or in whole by a computer processor such as controller/processor 105 as shown in the computing device 100 of FIG. 1.

Method 200 may include periodically (e.g. regularly, on a schedule, from time to time or irregularly, etc.) checking a data storage for queued schedule trade requests (Step 202). The data storage may be associated with a computing device, such as a server. A schedule trade request submitted by an agent may be queued (e.g. may be a “queued schedule trade request”) if, for example, the schedule trade request relates to a date or time that is not currently available to be traded. For example, an agent may want to trade their existing shift for a shift on Monday at 9 am, but the 9:00 AM shift on Monday is not currently available to be traded. Embodiments of the invention may hold such a request in a trade queue. In some embodiments, a queued schedule trade request remains queued until it is approved, rejected, or a predetermined period of time elapses. In some embodiments, the predetermined period of time expires at the date or time which is the subject of the queued schedule trade request. For example, at 9:00 AM on Monday if the trade request has not been approved, it may expire (which may include an automatic rejection). A new trade request may then be submitted by the agent for a different date or time.

Trade requests may be initiated by an agent, for example initiated using an agent terminal. An agent terminal may be a computing device, such as computing device 100 shown in FIG. 1. An agent terminal may be, for example, a personal computer, laptop, smartphone, digital tablet, or the like.

Method 200 may include identifying two corresponding queued schedule trade requests (Step 204). Two schedule trade requests may be corresponding if, for example, they relate to a same date or time; a same set of dates or times; a partially overlapping set of dates or times; or the like; or if they include data or metadata which is equal or equivalent.

If, as part of method 200, two corresponding queued schedule trade requests are not identified, method 200 may include identifying a set of cyclic queued schedule trade requests, e.g. as an ELSE condition (Step 206). For example, there may be no schedule trade requests in the queue which are corresponding, thus preventing a trade from being carried out between two agents and prompting embodiments of the invention to look for larger sets of corresponding trade request, e.g. cyclical trade requests between three, four, five, or more agents (e.g. between more than two agents).

A set of schedule trade requests may be cyclic, if, for example, more than two entities wish to trade requests such that at least some information in the trade requests correspond to or relate to each other, e.g. as in the case that a first agent wants to trade their first shift for a second shift of a second agent, and the second agent wants to trade their second shift for a third shift of a third agent, where the third agent wants to trade their third shift for the first shift of the first agent. Other cyclic permutations are possible, and for more than 3 agents.

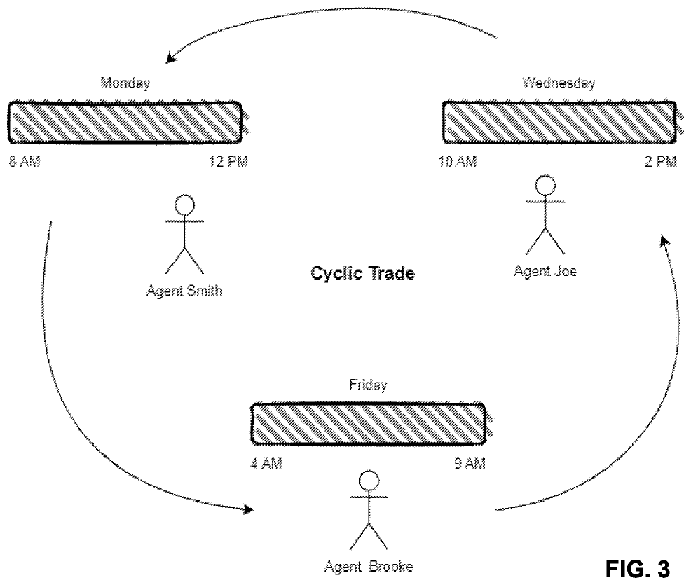

FIG. 3 shows an example of a set of cyclic trades, according to some embodiments of the invention. In the above example, Agent Smith works on Monday 8:00 AM to 12:00 PM and wants to work on Friday 4:00 AM to 9:00 AM. Agent Brooke has this shift on Friday, but he does not want to work on Monday and instead wants a shift on Wednesday that matches with Agent Joe's shift on Wednesday 10:00 AM to 2:00 PM. Agent Smith cannot trade directly with Agent Brooke and exchange their shifts; however they can trade via Agent Joe. Agent Smith will work on Agent Brooke's shift and Agent Brooke will work on Agent Joe's shift and Agent Joe will replace Agent Smith on Monday. This type of cyclic trade is not present in existing WFM systems. When such trades are not available, the agents may be dissatisfied with not getting the preferred shifts or might opt for time off. Instead of getting into an understaffed situation, embodiments of the invention provide a solution to this problem.

Returning to FIG. 2, if a set of cyclic queued schedule trade requests are not identified, method 200 may repeat the step of periodically checking, e.g. repeat step 202 as an ELSE condition (Step 208). For example, there may not currently be any corresponding schedule trade requests or set of schedule trade requests forming a cyclic trade request, thus preventing any type of trade from being carried out between two or more agents and prompting embodiments of the invention to wait and recheck the trade queue at a later point in time, by which time new corresponding or sets of cyclic trade requests may have been received.

Periodically checking may include, for example, checking every 1 minute, every 30 minutes, every hour, every 24 hours, etc.

Method 200 may include approving or rejecting the identified schedule trade requests based on one or more approval criteria (Step 210). Due to the ELSE conditions, the identified schedule trade requests will be one of: two corresponding queued schedule trade requests; or a set of cyclic queued schedule trade requests. The one or more approval criteria may include, for example, a check that the trade request relates to at least one of: a tradeable activity; two or more agents in a same scheduling unit; and/or two or more agents with a same skill. Embodiments of the invention may compare data in a pre-defined data store of skills and scheduling units associated with agents as part of the approval criteria checking. The data store may be, for example, memory 120 and/or storage 130 as shown in FIG. 1.

For example, whether a shift includes a tradeable activity may be determined by, for example, checking a pre-defined data store of activity types and a tradeable yes/no status (e.g. a Boolean value). The data store may be, for example, memory 120 and/or storage 130 as shown in FIG. 1.

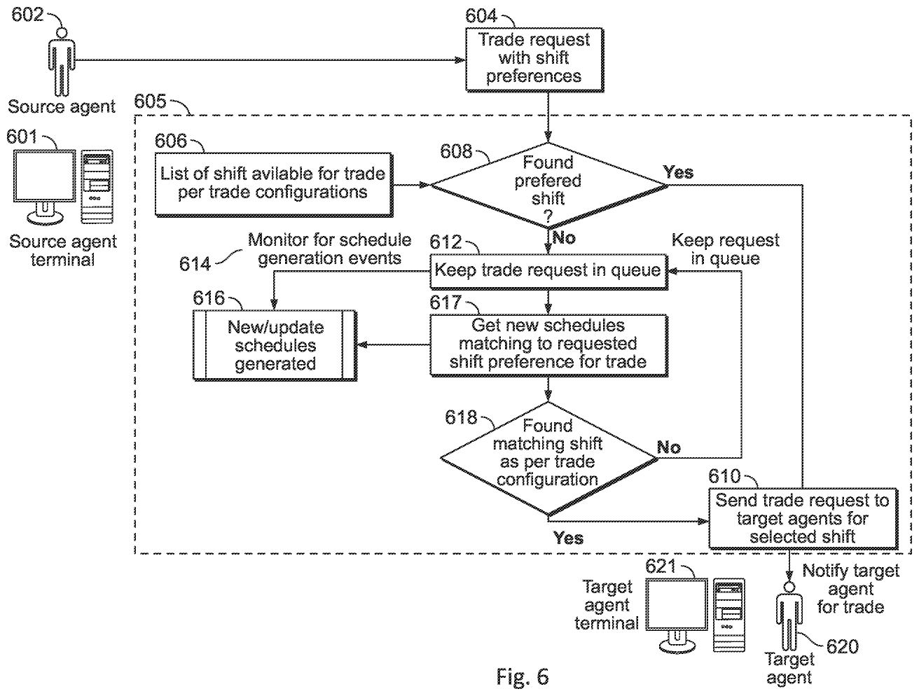

If the approval criteria are not satisfied, embodiments of the invention may automatically reject the identified schedule trade requests. The agents who submitted the rejected requests may be automatically notified of the rejection (e.g. by email, short message service (SMS), in-system message, or the like), e.g. via agent terminal 601 shown in FIG. 6. In some embodiments, the schedule trade requests are not rejected, but are returned to the data storage of queued schedule trade requests to await another schedule trade request or set of schedule trade requests which may result in approval, for example because such trade requests relate to the same tradeable activity, same scheduling unit, and/or same skill.

Method 200 may include, if the identified schedule trade requests were approved, outputting, displaying or transmitting one or more updated schedules reflecting the approved schedule trade requests (Step 212). For example, updating a schedule of each agent may include substituting the shifts of one agent for the shifts of another agent on the relevant days. The schedule may be an online accessible schedule, such as in a dashboard or user area of a web-based or downloadable application/app.

In some embodiments of the invention, an approval notification is sent to the set of agents who are the subject of an approved schedule trade request. For example, the set of agents may be two agents with corresponding schedule trade requests, or more than two agents whose schedule trade requests for a cyclic schedule trade request. The notification may be, for example, an email, an SMS, in-system message, or the like.

According to some embodiments of the invention, method 200 may further include periodically checking the data storage for new schedules, and identifying the two corresponding queued schedule trade requests or the set of cyclic queued schedule trade requests based on the new schedules. For example, during a period of time between a schedule trade request being submitted and being approved, new schedules may have been created, uploaded, and/or published, for example by a manager, or by an automatic process. Embodiments of the invention may check such new schedules and attempt to identify two corresponding queued schedule trade requests or a set of cyclic trade requests which, whilst not corresponding or cyclic based on a previous schedule, are now corresponding or cyclic based on the newly available schedules.

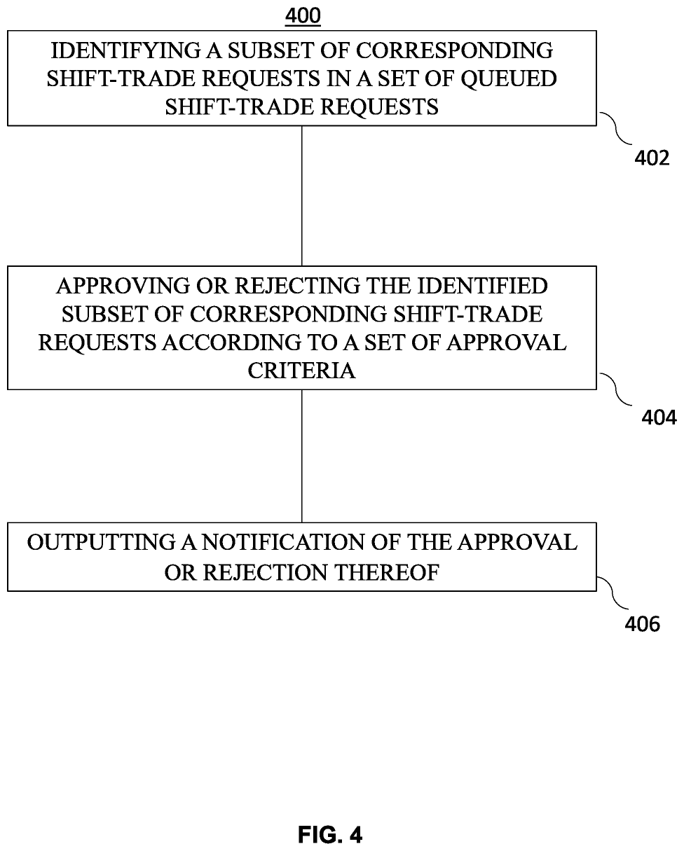

According to one more embodiments of the invention, there is provided a method 400 for digital scheduling as shown in FIG. 4. Method 400 may include, using a computer processor, identifying a subset of corresponding shift-trade requests in a set of queued shift-trade requests (Step 402).

For example, shift-trade requests (which may also be referred to as schedule trade requests) may be queued as described herein, for example because the target shift relating to the shift-trade request is not available or does not exist to be traded. Such queued shift-trade requests may for a set of shift-trade requests in a queue. A subset of corresponding shift-trade requests of the set of queue shift-trade requests may be, for example, two shift-trade requests where a shift to be traded and a desired target shift of one request correspond to a desired target shift and shift to be traded of another shift-trade request.

For example, a first shift-trade request may seek to trade shift X of a specified date or time for shift Y of a specified date or time. If a second shift-trade request seeks to trade shift Y for shift X, then these two shift-trade requests may be considered as corresponding.

A subset of corresponding shift-trade requests of the set of queue shift-trade requests may be, for example, a cyclic subset of corresponding shift-trade requests, as described herein. For example, the cyclic subset may relate to shifts X, Y, and Z, of specified dates or times. A first shift-trade request which seeks to trade shift X for shift Y, a second shift-trade request which seeks to trade shift Y for shift Z, and a third shift-trade request which seeks to trade shift Z for shift X may be such a corresponding cyclic subset of shift-trade requests. Cyclic subsets may relate to numbers of shift-trade requests other than 3, and it will be understood that other cyclic permutations are possible.

Method 400 may include approving or rejecting the identified subset of corresponding shift-trade requests according to a set of approval criteria (Step 404). The approval or rejection may be automatic and based solely on the approval criteria without input from a human manager. The approval criteria may be as described herein.

Method 400 may include outputting a notification of the approval or rejection thereof (Step 406). For example, method 400 may include sending to one or more agents who submitted approved or rejected shift-trade requests an email, SMS, in-system message, or the like notifying such agents of the outcome of their shift-trade requests.

Method 400 may further include outputting an updated schedule for an approved shift-trade request. For example, if a shift-trade request (e.g. as part of a subset of shift-trade requests) is approved, then embodiments of the invention may output an adjusted schedule which has been amended to reflect the shift-trade. Each agent affected by the change may receive such an updated schedule, which may be sent digitally, for example by email.

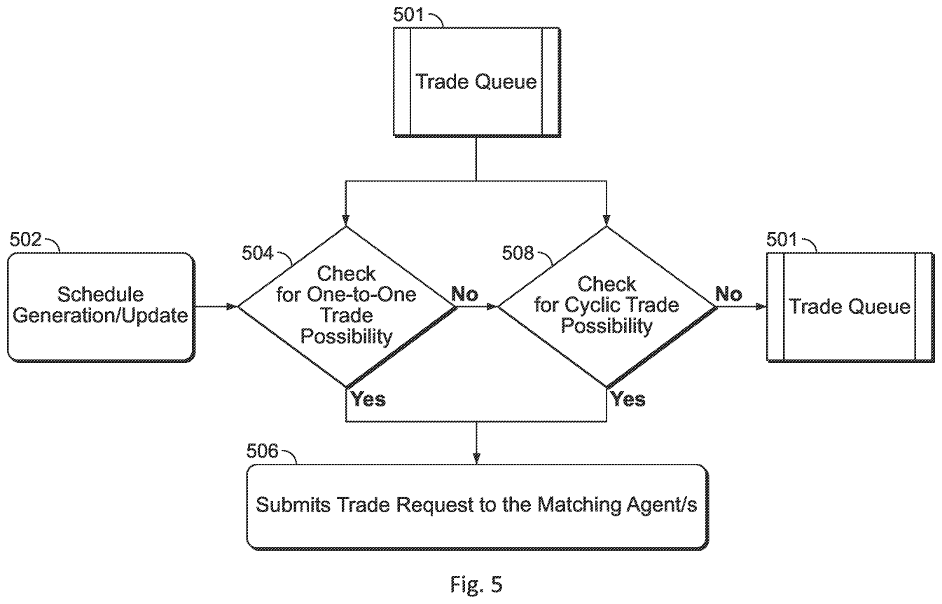

FIG. 5 shows a flowchart of a method according to some embodiments of the invention. In FIG. 5, at Step 502, schedules may have been generated (e.g. new schedules) or updated, for example by a manager or an automatic process.

At Step 504, embodiments of the invention may check the trade queue 501 for one-to-one trade possibilities. For example, a one-to-one trade possibility may be achieved for two corresponding schedule trade requests which correspond for the same dates and times as described herein. If a one-to-one trade possibility is identified, embodiments of the invention may submit the trade request to the matching agents (Step 506), for example so that the agents can decide if they wish to accept the trade request.

If no one-to-one trade possibility is identified, embodiments of the invention may check trade queue 501 for a cyclic trade possibility (Step 508). If a cyclic trade possibility is identified, embodiments of the invention may submit the trade request to the matching agents (Step 506).

If no cyclic trade possibility is identified, embodiments of the invention may leave trade requests in the trade queue, and may repeat the steps of checking at a later date or following newly generated or updated schedules.

FIG. 6 shows a flow diagram according to some embodiments of the invention. A source agent 602 may use a computing device such as an agent terminal 601 to submit a trade request 604 with shift preferences. The shift preferences may include, for example, a date or time of the shift they wish to trade away (e.g. a source shift), and a date or time of a shift they wish to take on (e.g. a target shift).

At a server side 605 handling the request (e.g. a computing device which may be a server), the server may have access to (e.g. in a data storage such as storage 130 shown in FIG. 1) a list 606 of shifts available for trade based on one or more predefined trade configurations. Server 605 may attempt to find a preferred shift 608. The preferred shift may be, for example, a shift matching or corresponding to the trade request.

If server 605 identifies such a preferred shift 608, the server may send (610) the trade request to a target agent 620 having the related target shift and notify the target agent that a trade request for their shift has been made. The target agent 620 may view and accept/decline the request using a computing device such as an agent terminal 621.

If server 605 does not identify a preferred shift 608, the trade request may be kept in a trade queue 612.

Server 605 may monitor (614) for schedule generation events (e.g. monitor a connected communications network). When new schedules 616 are generated or updated, server 605 may retrieve (617) new schedules which relate to one or more requests kept in trade queue 612 (e.g. if a queued trade request involves a Monday, server 605 may retrieve new schedules for Mondays).

If server 605 identifies a matching shift 618 as per the trade configurations, server 605 may send (610) the trade request to a target agent 620 having the related target shift and notify the target agent that a trade request for their shift has been made. The target agent 620 may view and accept/decline the request using the computing device 621.

If server 605 does not identify a matching shift, the trade request may be kept in trade queue 612. periodic monitoring by server 605 for newly generated/updated schedules may result in the trade request leaving the trade queue and being sent to a target agent for acceptance.

If target agent 620 declines a trade request, the trade request may be returned to trade queue 612.

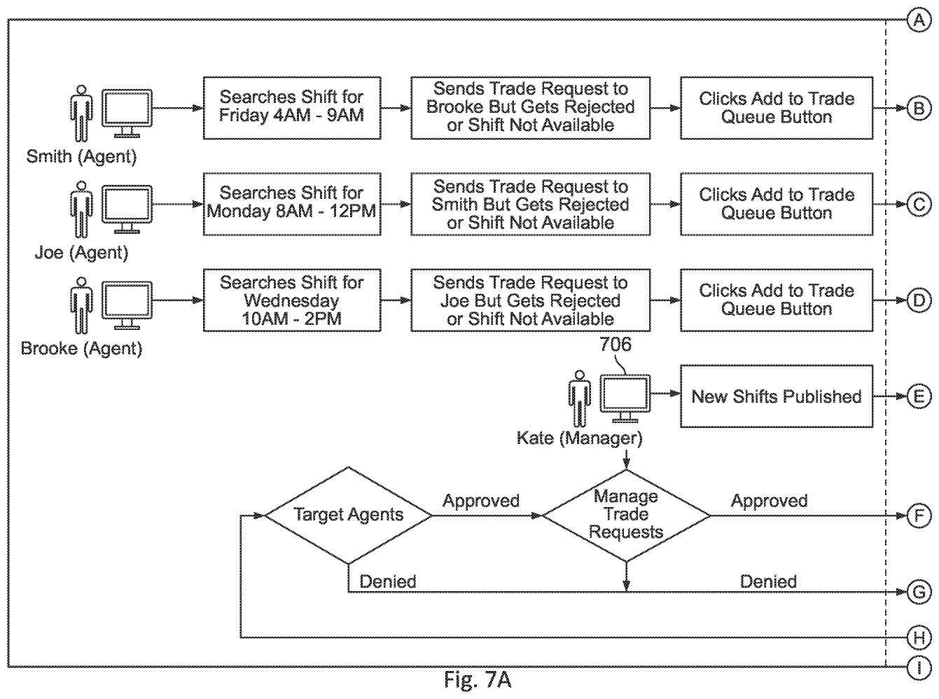

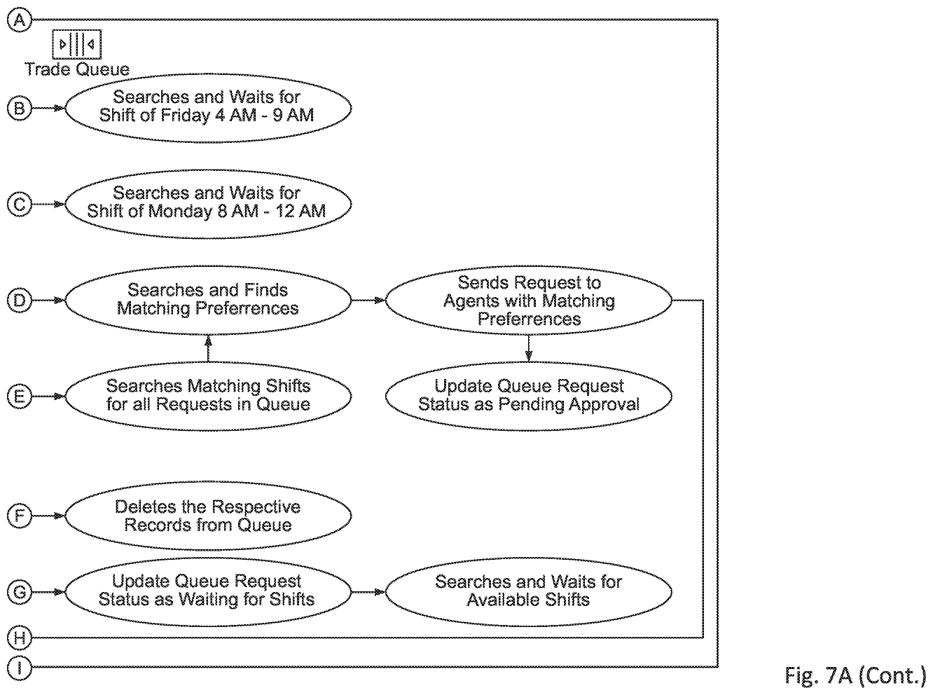

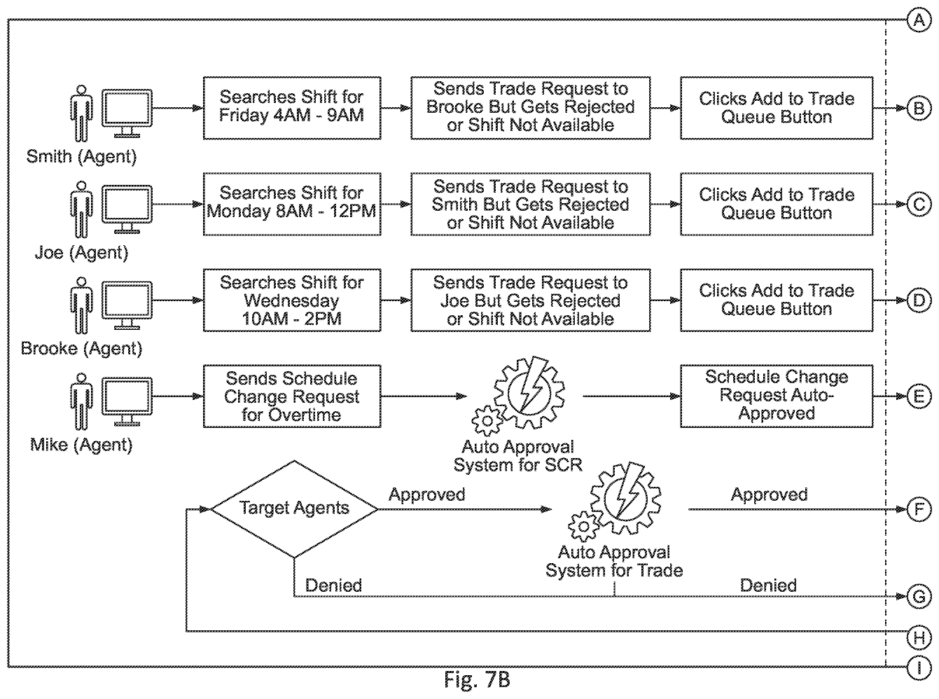

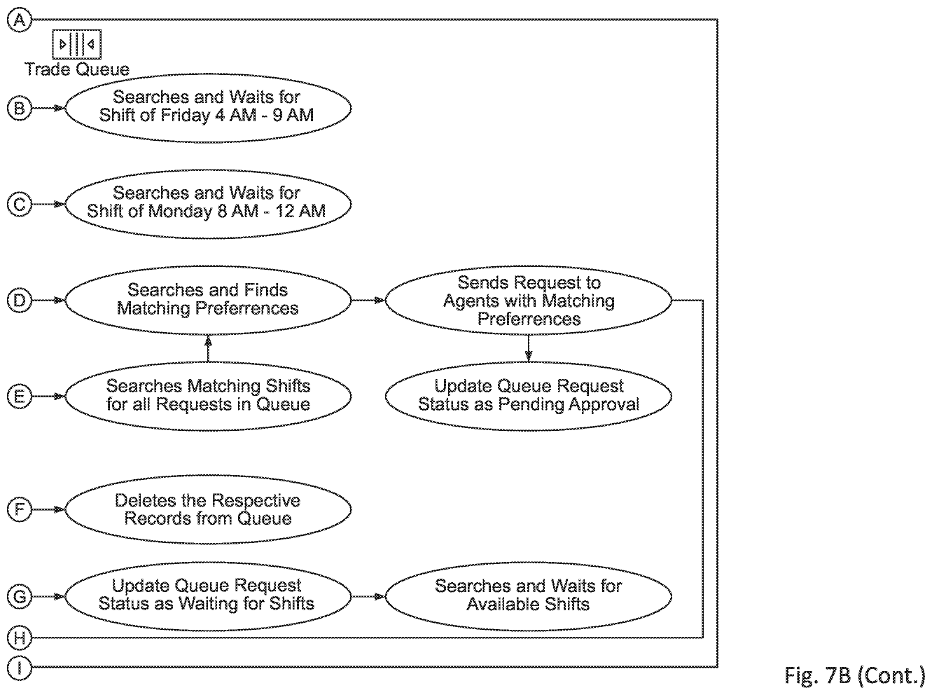

FIGS. 7A and 7B show an example according to some embodiments of the invention. The example shifts and agents are as given for FIG. 3.

For example, Agent Smith wants to work on Friday 4:00 AM-9:00 AM and sends a trade request for this shift to Agent Brooke. The trade request is rejected by Agent Brooke as they do not want to work on Friday. In this example, there are no other Friday 4:00 AM-9:00 AM shifts available. Agent Smith can click an “Add to Queue” button, for example by providing an input to an agent terminal, such as agent terminal 601 shown in FIG. 6. Systems according to embodiments of the invention will keep searching for the preferred shift availability after every new schedule is generated or the existing schedule is updated and waits until the shift for Friday 4:00 AM-9:00 AM is available to trade.

Similarly, Agent Joe wants to work on Monday 8:00 AM to 12:00 PM and sends a trade request to Agent Smith. The trade request is rejected by Agent Smith as they do not want to work on Monday at the given time. In this example, there are no other Monday 8:00 AM-12:00 PM shifts available. In this scenario, Agent Joe can click on the Add to Queue button. The system will keep searching for the preferred shift availability after every new schedule is generated or the existing schedule is updated and waits until the shift for Monday 8:00 AM-12:00 PM is available to trade.

Similarly, Agent Brooke wants to work on Wednesday 10:00 AM to 2:00 PM and sends a trade request to Agent Joe. The trade request is rejected by Agent Joe as they do not want to work on Wednesday at the given time. In this example, there are no other Wednesday 10:00 AM-2:00 PM shifts available. In this scenario, Agent Brooke can click on the Add to Queue button. The system will keep searching for the preferred shift availability after every new schedule is generated or the existing schedule is updated and waits until the shift for Wednesday 10:00 AM-2:00 PM is available to trade for Agent Brooke.

A process such as a trade queue engine may wait and search for the preferred shifts in the system, and try to match shifts with all the requests in the queue. Whenever a match is found, it may send the request to the agent with the matching preferences with all the details. Once accepted by the target agent, it will update the request in the queue with the status of Pending Approval. For example, as shown in FIG. 3, a cyclic shift trade is possible between Agents Smith, Joe and Brooke.

A manager may use a manual approval flow, e.g. by providing input to and using a manager terminal, such as terminal 706 shown in FIG. 7A, to approve or reject accepted trade requests. For example, a target agent may accept a trade request, but that accepted trade between source agent and target agent may still be subject to approval, for example approval by a manager, to ensure, for example, that the trade will not leave the contact center understaffed in a particular skill (e.g. a customer service agent trading shifts with a sales agent where there is no overlap in required skills for those traded shifts).

Once an accepted trade request has been approved, it may be removed (e.g. deleted) from the trade queue. If an accepted trade request is rejected (e.g. not approved), any “pending approval” status may be removed from the trade request, and the trade request may remain in the trade queue, with the trade queue engine periodically checking for any shift updates to try and match the queued trade request.

FIG. 7B shows a similar example to that of FIG. 7A, but where an automatic approval process may be implemented. In FIG. 7B, Agent Mike requests a schedule change for overtime (for example using an overtime request process provided by a WFM application). The request may be automatically approved, and thus a new schedule may be generated for Agent Mike, which may make one or more unavailable shifts waiting to be traded in the trade queue available. Upon acceptance of a trade request sent to a target agent, embodiments of the invention may automatically approve the accepted trade request subject to predefined approval criteria. For example, the approval criteria may include a check that the trade request relates to at least one of: a tradeable activity; two or more agents in a same scheduling unit; and two or more agents with a same skill.

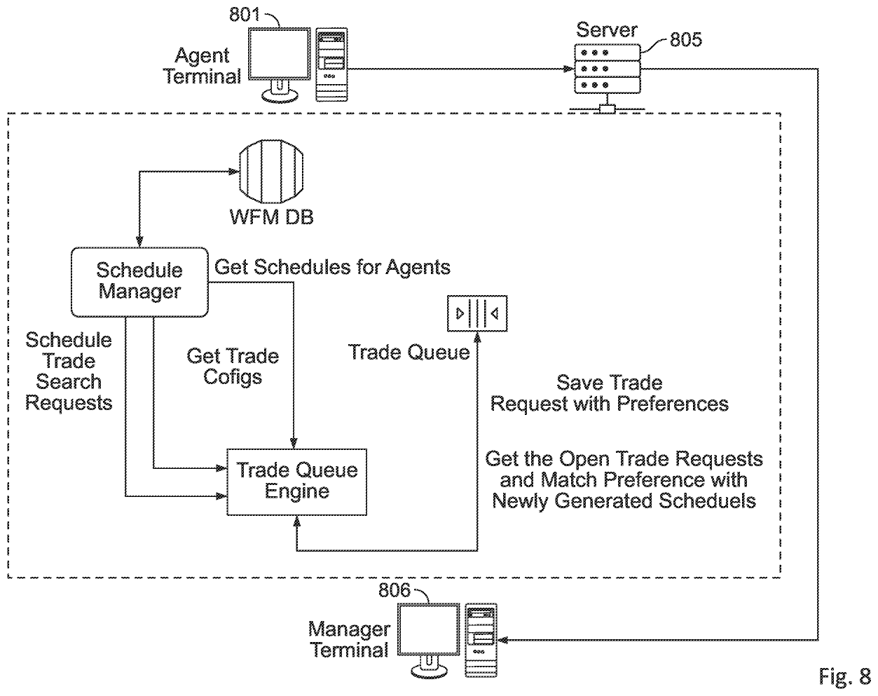

FIG. 8 shows a component diagram, according to some embodiments of the invention. Fig, 8 shows how an agent terminal 801, a server 805 and a manager terminal 806 may interact. For example, an agent may provide input to agent terminal 801 in the form of a trade request, which may be sent to and processed by server 805, and which may be approved or rejected by a manager by giving an input to manager terminal 806. Embodiments of the invention, such as a system implementing methods disclosed herein, may perform the steps of:
1. Getting the schedules for all the agents from the Schedule manager;
2. Matching the trade request preferences with the trade configurations;
3. Executing a trade queue engine as part of a Schedule Manager Microservice to get the open trade requests and match preferences with the newly generated schedules; and
4. if no matching trade option is found, save the trade requests with the preferences in the trade queue.

Thus, FIG. 8 shows how embodiments of the invention may be integrated with, and may influence, existing processes and architecture components of existing WFM applications. For example, embodiments of the invention may affect and improve, technology such as a Schedule Requests Manager microservice (MS) and/or a Schedule manager microservice. A Schedule Requests Manager allows agents to request changes to their own schedules by using Shift Trade, and to allow processing of Trade requests for Auto approval. These requests include any activity which is marked as tradable in the Schedule Manager trade configuration. A Schedule Manager may be a core application in a scheduling system. The Schedule Manager may be responsible for storing and retrieving schedule data, net staffing data, and all configurations required to generate schedules including daily rules, weekly rules, and activity codes, and stores the shift trade configuration of the system. Such data may be stored in a WFM database.

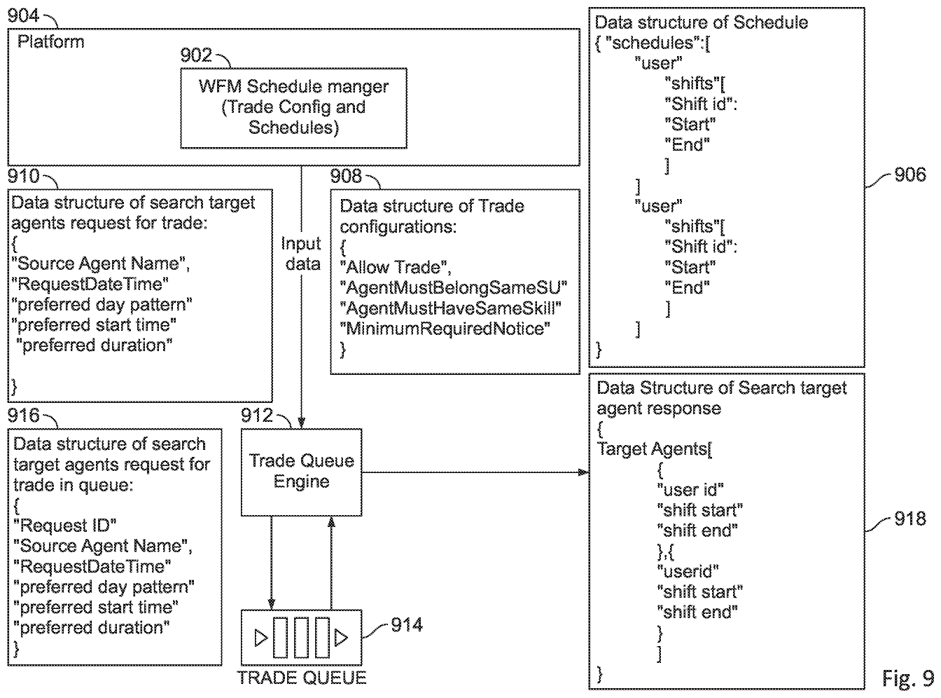

FIG. 9 shows example data structures which may be used by embodiments of the invention.

For example, embodiments of the invention, may use a WFM schedule manager 902, which may be part of a platform such as CxOne platform 904 provided by NICE LTD. The schedule manager may include, use, or access data such as trade configurations and schedules.

A schedule data structure 906 may include, for example, the following data: user (e.g. a universally unique identifier, UUID); shift id (e.g. a UUID); start (e.g. a timestamp); and/or end (e.g. a timestamp).

A trade configuration data structure 908 may include, for example, the following data: allow trade (e.g. a Boolean value); agent must belong to the same scheduling unit (e.g. a Boolean value); agent must have the same skill (e.g. a Boolean value); and/or minimum required notice (e.g. an integer time).

A data structure 910 for searching target agents in response to a request to trade may include, for example, the following data: source agent name (e.g. a string); request date time (e.g. a timestamp); preferred day pattern; preferred start time (e.g. a timestamp); preferred duration (e.g. an integer time).

Data such as in data structures 906, 908, and/or 910 may be input to trade queue engine 912. Trade queue engine 912 may be as described herein, and may be, for example, a process, software, or code running on a computing device, such as a server (e.g. server 605 shown in FIG. 6, and server 805 shown in FIG. 8).

Trade queue engine may operate, maintain, or otherwise interact with trade queue 914. Trade queue 914 may be as described herein, and may be, for example, a memory or data storage such as storage 130 shown in FIG. 1.

Trade engine 912 may search trade queue using data structure 916. Data structure 916 may include, for example, the following data: request ID (e.g. a UUID); source agent name (e.g. a string); request date time (e.g. a timestamp); preferred day pattern; preferred start time (e.g. a timestamp); preferred duration (e.g. an integer time).

A data structure 918 for searching target agent responses may include, for example, the following data: user id (e.g. a UUID), shift start (e.g. a timestamp), shift end (e.g. a timestamp).

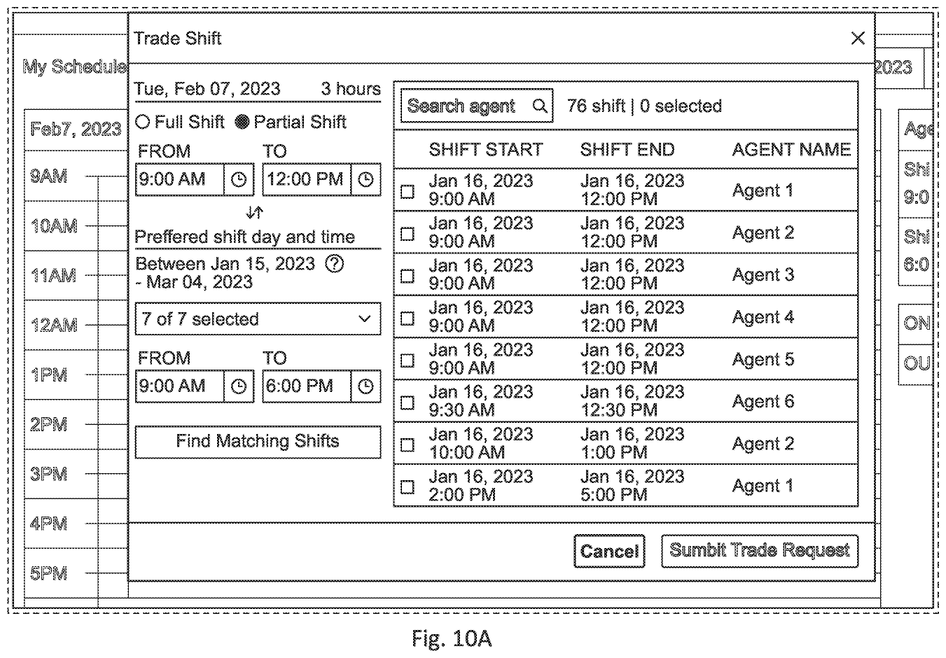

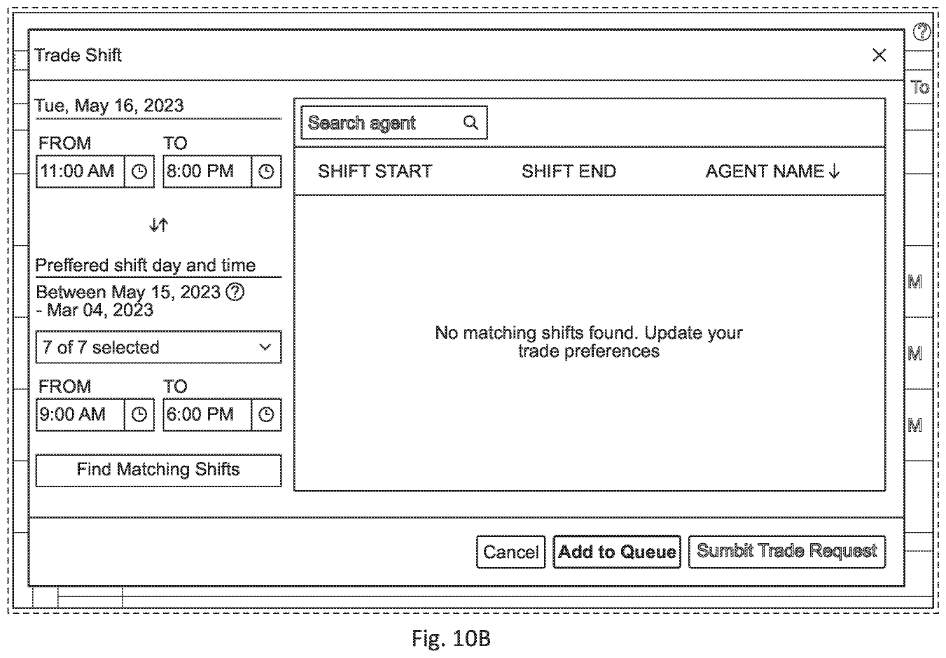

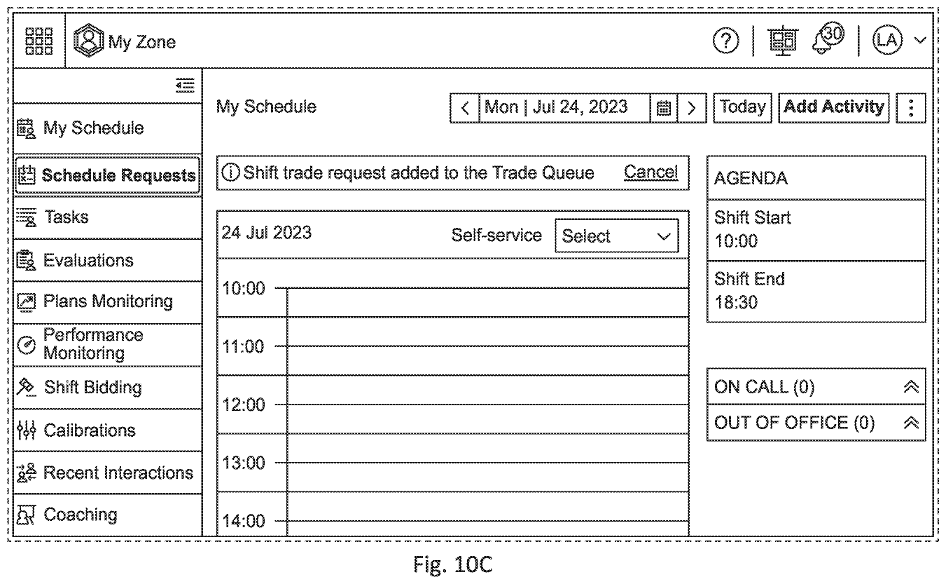

FIGS. 10A, 10B, and 10C show example user interfaces which may be used with embodiments of the invention. Schedule trade requests may be submitted by an agent via a user interface such as that shown in FIG. 10A, which may show available target agents with which to trade shifts. If systems according to embodiments of the invention do not identify any target agents matching the trade preferences of the source agent, the source agent may be notified that no matching shifts were found, as shown in FIG. 10B. The source agent may be prompted to update their shift preferences. The source agent can select “add to queue” to place their shift trade request in the trade queue if they want to wait for their preferred shift to become available.

FIG. 10C shows an example message which may be displayed to a source agent upon selecting to add their trade request to the trade queue. The source agent can have the opportunity to cancel their queued trade request at any time.

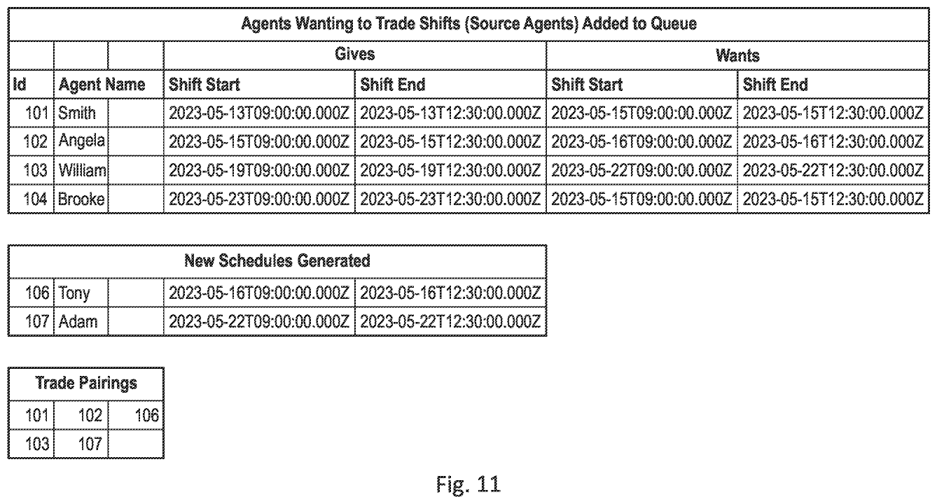

FIG. 11 shows an example simulation, according to some embodiments of the invention. According to the simulation, trade requests 101, 102, and 106 are identified as a set of cyclic trade requests, and trade requests 103 and 107 are identified as corresponding trade requests.

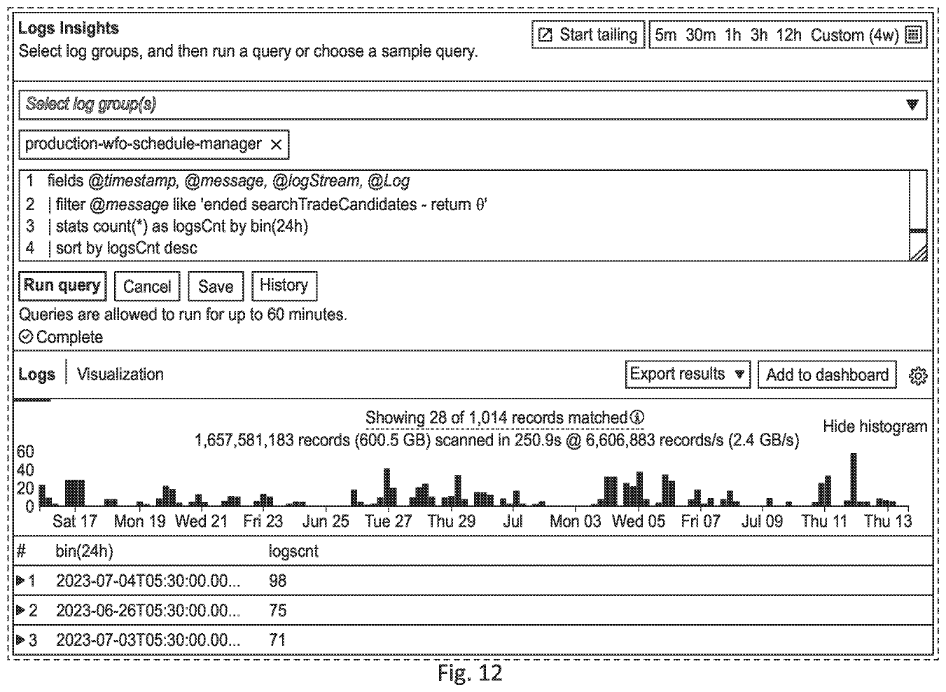

FIG. 12 shows some example data in relation to embodiments of the invention. Logs from Production environments show that, without the present invention, typically 100 requests per day are result in “No matching shifts found”. This shows that embodiments of the invention may solve a gap in WFM trade systems and can bring substantial benefits to the contact centers. For example: agents may be happy to have the preferred shifts available for work; managers can maintain the staffing conditions on their team; the contact center will benefit as agents will avoid taking time off and the staffing levels are well maintained; and customers may remain happy without any interruption in work.

Furthermore, embodiments of the invention may not require a human manager to approve requests, and thus overhead can be reduced, and efficiency improved.

The present invention may be embodied as a non-transitory computer readable storage medium containing instruction which, when executed by at least one processor in a computing device (such as computing device 100 of FIG. 1), cause the at least one processor to carry out methods as described herein.

The present invention may also be embodied as a system, for example a system which includes at least one processor; and a computer readable storage medium (such as a memory) containing instructions which, when executed by the at least one processor, cause the at least one processor to carry out one or more methods described herein, such as method 200 and/or 300.

For example, embodiments of the invention may be carried out by a computing device as shown in FIG. 1, integrated into an existing WFM architecture, or operating a new WFM architecture. The at least one processor may: periodically check a data storage for queued schedule trade requests; identify two corresponding queued schedule trade requests; else, if two corresponding queued schedule trade requests are not identified: identify a set of cyclic queued schedule trade requests; else, if a set of cyclic queued schedule trade requests are not identified: repeat the step of periodically checking; approve or reject the identified schedule trade requests based on one or more approval criteria; and if the identified schedule trade requests were approved, output one or more updated schedules reflecting the approved schedule trade requests.

Although embodiments have been described in the context of agents in a contact center, other contexts may be used.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for digital scheduling, the method comprising, using a computer processor:
periodically checking a data storage for queued schedule trade requests;
identifying two corresponding queued schedule trade requests;
else, if two corresponding queued schedule trade requests are not identified:
identifying a set of cyclic queued schedule trade requests;
else, if a set of cyclic queued schedule trade requests are not identified:
repeating the step of periodically checking;
approving or rejecting the identified schedule trade requests based on one or more approval criteria; and
if the identified schedule trade requests were approved, outputting one or more updated schedules reflecting the approved schedule trade requests.

2. The method of claim 1, further comprising:
periodically checking the data storage for new schedules; and
identifying the two corresponding queued schedule trade requests or the set of cyclic queued schedule trade requests based on the new schedules.

3. The method of claim 1, wherein the approval criteria comprises a check that the trade request relates to at least one of: a tradeable activity; two or more agents in a same scheduling unit; and two or more agents with a same skill.

4. The method of claim 1, where a schedule trade request submitted by an agent is queued if the schedule trade request relates to a date or time that is not currently available to be traded.

5. The method of claim 1, wherein a queued schedule trade request remains queued until it is approved, rejected, or a predetermined period of time elapses.

6. The method of claim 5, wherein the predetermined period of time expires at the date or time which is the subject of the queued schedule trade request.

7. The method of claim 1, comprising sending an approval notification to a set of agents who are the subject of an approved schedule trade request.

8. A method for digital scheduling, the method comprising, using a computer processor:
identifying a subset of corresponding shift-trade requests in a set of queued shift-trade requests;
approving or rejecting the identified subset of corresponding shift-trade requests according to a set of approval criteria; and
outputting a notification of the approval or rejection thereof.

9. The method of claim 8, further comprising outputting an updated schedule for an approved shift-trade request.

10. The method of claim 8, wherein a shift-trade request is a queued shift-trade request if at the time an agent submitted the shift-trade request the shift did not exist to be traded.

11. A system for digital scheduling, the system comprising:
at least one processor; and
a memory containing instructions which, when executed by the at least one processor cause the at least one processor to:
periodically check a data storage for queued schedule trade requests;
identify two corresponding queued schedule trade requests;
else, if two corresponding queued schedule trade requests are not identified:
identify a set of cyclic queued schedule trade requests;
else, if a set of cyclic queued schedule trade requests are not identified:
repeat the step of periodically checking;
approve or reject the identified schedule trade requests based on one or more approval criteria; and
if the identified schedule trade requests were approved, to output one or more updated schedules reflecting the approved schedule trade requests.

12. The system of claim 11, wherein the at least one processor is further configured to:
periodically check the data storage for new schedules; and
identify the two corresponding queued schedule trade requests or the set of cyclic queued schedule trade requests based on the new schedules.

13. The system of claim 11, wherein the approval criteria comprises a check that the trade request relates to at least one of: a tradeable activity; two or more agents in a same scheduling unit; and
two or more agents with a same skill.

14. The system of claim 11, where a schedule trade request submitted by an agent is queued if the schedule trade request relates to a date or time that is not currently available to be traded.

15. The system of claim 11, wherein a queued schedule trade request remains queued until it is approved, rejected, or a predetermined period of time elapses.

16. The system of claim 15, wherein the predetermined period of time expires at the date or time which is the subject of the queued schedule trade request.

17. The system of claim 11, wherein the at least one processor is further configured to send an approval notification to a set of agents who are the subject of an approved schedule trade request.
